(19) United States
(12) Patent Application Publication
(10) Pub. No.: US 2014/0278721 A1
(43) Pub. Date: Sep. 18, 2014

(54) GLOBAL OPTIMIZATION STRATEGY SYSTEM AND METHOD OF USE

(71) Applicants: Lisa M. Giles, Lake Forest, IL (US); Robert C. Hollar, Libertyville, IL (US)

(72) Inventors: Lisa M. Giles, Lake Forest, IL (US); Robert C. Hollar, Libertyville, IL (US)

(21) Appl. No.: 14/213,434

(22) Filed: Mar. 14, 2014

Related U.S. Application Data
(60) Provisional application No. 61/792,410, filed on Mar. 15, 2013.
(60) Provisional application No. 61/792,490, filed on Mar. 15, 2013.

(51) Int. Cl. G06Q 10/06

(52) U.S. Cl. CPC G06Q 10/06316
USPC 705/7.26

(57) ABSTRACT

The present invention relates to a software based system implemented on a standalone computer of over a network using computers for collecting global optimization related data, processing the country specific data, to objectively qualify, prioritize, and manage the information to formulate and implement a global optimization strategy for goods or services and the associated method of use therefore. The system operates by interfacing four modules with a database manager, a catalog (data storage and retrieval) module, an analytical (opportunity qualifier) module, a priority ranking module, and a reporting and mapping module. The software can be applied to geographically optimize existing or new products, product-lines, or services. For existing products or services the result may be to correct the priority generally obtained and ranked using non opportunity-based evaluations and rankings, or expand into additional countries. For new products or services, the results can be used to sequence country participation (order-of-entry, level of participation, etc.) for the company and/or partners.

### CLAIM OF PRIORITY

The present continuation application is a non-provisional utility application claiming priority from and the benefit of a U.S. Provisional Utility Application No. 61/792,410, filed Mar. 15, 2013, entitled GLOBAL LAUNCH OPTIMIZATION SYSTEM AND METHOD OF USE, which application is hereby incorporated fully by reference, and U.S. Provisional Utility Application No. 61/792,490, entitled GLOBAL EXPANSION STRATEGY SYSTEM AND METHOD OF USE, which application is also hereby incorporated fully by reference.

### FIELD OF THE INVENTION

The present invention relates to a software based system implemented on a standalone computer of over a network using computers for collecting global expansion related data, processing the global optimization related data, to prioritize, manage and quantify the information and formulate and implement a global optimization strategy for goods, services or partnerships and the associated method of use therefore.

### BACKGROUND

Company launches and participation in countries has been primarily based on subjective information and limited by regional or national experience. Many companies have established access across geographies and have a mix of capabilities, product offerings, and partnerships across the globe. In the past, while a many corporations could hope to grow any product internationally, with the arrival of the internet, the collection of large volume of data, and computers, it is now possible to use tools and systems to help qualify global, regional, and country opportunities that were once considered impossible to synthesize. But collecting and managing large volumes of data into an objective, coherent and useful way has proven to be the next challenge. Today, in the field of global optimization strategy systems and methods of use, no invention exists to collect and structure data, store the storage, and generate useful data reports in a way that helps prioritize countries or opportunities internationally a new product, product-line, or service.

Further, global decisions are rendered complex because of the rules and interplay between different countries between which, and in which different rules, sociologies, epidemiology, and financial parameters apply. For example, the seller of a pair of jeans wishing to enter different countries around the world must collect data. Are both genders consumers of jeans, what are wearing patterns, what is the local purchasing climate, what are fashion cycles, etc.? As part of the decision to sell, expand or partner globally any product or service, multiple other factors such as the use of licenses, payers, local distributors, the location of manufacturing facilities, local regulatory legislations, transportation parameters, tax rates, etc. are of great importance.

In the case of the sale around the world of jeans, a business decider will often be paralyzed by the task ahead. He or she will be flooded with information like the capacity of local inhabitants to wear certain types of clothing, cultural preferences, weather conditions in a country, cultural variations, marketing channels, counterfeit issues, the cost of retail and distributorship, the presence of the internet, to name only a few. Faced with this many variables, even with information available via an online search, the task can easily seem overwhelming and decision making will often be spotty and uncertain.

What is needed is a software based system, and the associated method of use implemented either on a standalone computer of over a network with multiple computers for collecting global optimization data, processing this country-specific data, and analyzed in a way to help a user understand, prioritize, manage and quantify the information on a consistent basis into a coherent and useful global optimization strategic plan for goods or services.

### SUMMARY

The present invention relates to a software based system implemented on a standalone computer of over a network using computers for collecting global optimization related data, processing the country specific data, to objectively qualify, prioritize, and manage the information to formulate and implement a global optimization strategy for goods or services and the associated method of use therefore. The system operates by interfacing four modules with a database manager, a catalog (data storage and retrieval) module, an analytical (opportunity qualifier) module, a priority ranking module, and a reporting and mapping module. The software can be applied to geographically optimize existing or new products, product-lines, or services. For existing products or services the result may be to correct the priority generally obtained and ranked using non opportunity-based evaluations and rankings, or expand into additional countries. For new products or services, the results can be used to sequence country participation (order-of-entry, level of participation, etc.) for the company and/or partners.

### BRIEF DESCRIPTION OF THE DRAWINGS

Certain embodiments are shown in the drawings. However, it is understood that the present disclosure is not limited to the arrangements and instrumentality shown in the attached drawings.

FIG. 1 an illustration of a network-enabled or non-network-enabled hardware system where the different systems and methods disclosed herein can be implemented according to an embodiment of the present disclosure.

FIG. 2 is a second illustration of the network-enabled or non-network-enabled hardware system of FIG. 1 showing the internal structural components of some of the elements of the systems described herein.

FIG. 3 is a timeline illustrating the use of multiple different software tools and associated systems as part of an overall strategy to help with the global optimization and launch strategy system.

FIG. 4 is an illustration of the four main modules forming a first tool for the global optimization strategy as a system and method of use according to an embodiment of the present disclosure.

FIG. 5 is a detailed description of each of the four modules forming the global expansion strategy system of FIG. 4.

FIG. 6 is another illustration of one of the numerous data entry and selection entry tables to help a user of the system navigate and select the different output desired of the system shown at FIGS. 4 to 11, according to an embodiment of the present disclosure, which includes entering an opportunity.

FIG. 7 illustrates different screen shots of the different data parameters according to the embodiment shown at FIGS. 4 to 11 of the present disclosure.

FIG. 8 illustrates a global map illustrating different countries of interest forming a plan of action and a strategy generated by the system described at FIGS. 1, 2, and 4-7.

FIG. 9 is a detailed illustration of one of the output tables for generating country factors according to several of the embodiments of the present disclosure.

FIG. 10 is a detailed illustration of one of the output tables for generating an overall score according to several embodiments of the present disclosure.

FIG. 11 is a detailed illustration of the method of use of a computer enabled software system for the generation of a global optimization strategy of an item of interest into a plurality of jurisdictions according to an embodiment of the present disclosure.

FIG. 12 is an illustration of a typical Gantt chart from the prior art.

FIG. 13 is an illustration of two-axis of the launch optimization system with the commercial dimensions and the different project phases shown according to an embodiment of the present disclosure.

FIG. 14 is an illustration of the breakdown of initiatives and activities as part of the different commercial dimensions shown at FIG. 13, according to an embodiment of the present disclosure.

FIG. 15 is an illustration of the different data pages of information associated with each activity described at FIG. 14, according to an embodiment of the present disclosure.

FIG. 16 is an illustration of a different output screen display of the different indexing elements for each activities of an initiative, according to an embodiment of the present disclosure.

FIG. 17 is an illustration of the different modules forming the launch optimization system shown at FIGS. 1, 2, 12 to 16, according to an embodiment of the present disclosure.

FIG. 18 is an illustration showing sub-steps of the different modules described at FIG. 17, according to an embodiment of the present disclosure.

FIG. 19 is a diagram illustrating the methods of using the launch optimization system of shown at FIGS. 1, 2, and 12 to 17.

### DETAILED DESCRIPTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

While the invention as describes herein is primarily explained using a global or regional implementation of a marketing and sales strategy, one of ordinary skill in the art of software will recognize that the same logic and invention can be extrapolated and used to improve complex systems in smaller and more relevant geographical scales. For example, the owner of multiple parcels of real estate as the landlord may desire to manage two hundred units each with different renters, each having different living preferences, habits, etc. in different areas of a town. The differences between the need of each renter, the types of properties and their location will require the teachings of the current disclosure to help bring coherence and logic to this set of geographical data that otherwise has not real coherence.

Software operates as a set of instructions running in executable memory of a processor residing on a computer of some type. To fully enable the software and its functions described hereafter, the current disclosure begins with a summary of how computers are currently used alone or in a network configuration. FIGS. 1 and 2 illustrate two different versions of one possible hardware configuration 100 where a system can be implement on one or more computers 104, 105, and 106 used by different users 101, and connected over a network like a LAN or the Internet 103. The software can be either local or operating from a remote server 102 such as a web server over the internet. Further, with the rapid growth of internet technology and portable wireless technology, what is contemplated is the use of smart phones 110, hand held devices 111, different portable tablets 112, or a computer 113 in addition or instead of the different computers listed above.

FIG. 2, shows relatively the same type of hardware network but offers a look into the internals of the server 102 or a computer 104 connected to the network 103. While every computer is different, at the heart of these technologies are processors 6A, 6B (i.e. calculators) 3 capable of managing large series of calculations connected to memories 7A, 7B where data can process and a program running in the processor can be located. The memory 7A, 7B can also include long term memory, short term memory, or access only memory.

FIG. 2, shows some computers or devices 108, 105, 106, 104, 102, such as for example a web server 102 that may house a software platform 8, use the platform 8. Currently, many software will use a local HTML browser software installed on the computers, and their associated displays and interfaces, for example tablets, cell phones, portable or fixed computers with a commercial browser tool such as Internet Explorer® or Mozzilla® to exchange information in the form mostly of HTML script and data linked with the HTML script and display based on the format of the browser locally. The platform software 8, while programmed in any of multiple programming languages, relying on any of multiple database tools, can be made to read and generate content that can be accessed by the remote HTML browsers.

Overall System and Method

FIG. 3 shows along a horizontal arrow a timeline which includes generally three steps associated with large project management. The first is associated with the existence of current products and partnerships. The second is associated with the launch of new products, and the third is associated with the need for technology innovation.

As shown, four tools, in the form of systems operating in computers can be linked to form and offer a full service solution. As shown at FIG. 3, a first system called the global optimization strategy system and method of use thereof, as shown with greater detail at FIGS. 1, 2, and 4-11, offers inventory and mining of existing business for untapped global opportunities. This software is offered as GeoDecision™. The launch of new products can be split into two different steps. The first is directed to the optimization of launch of each new product globally. This system is called launch optimization system and method of use thereof. This software is offered as LaunchPath™. As part of the launch of new products, a third solution allows for the optimization of geographic launch sequence. This system, somewhat analogous to the GeoDecision™ solution is titled GeoSequence™. Finally, what is also contemplated is the use of tools and solutions to offer the preparation for market evolution and prioritization of opportunities for focused innovation.

GeoDecision™ and GeoSequence™

In one embodiment, the inventors have named the first use of this technology GeoDecision™ and the related second use GeoSequence™ as described above. These systems are database application designed to aid in the management of a global portfolio of product application, running the main kernel of software for an application either for use locally or via the network 103. On the other computers, a display 9, and an interface 10 can be used to across an array of country commercial infrastructure and sales and marketing partners as the different variable parameters. The tools, mostly directed at helping with global launch, product management and sales strategies of existing or new drugs or FDA approved products sold by pharmaceutical or healthcare product manufacturers provides multiple capabilities to facilitate product licensing, partnering, country infrastructure, marketing, data archiving, updating, analysis, and reporting, to enhance revenue growth efficiency and highlight areas where the greatest opportunity for growth or penetration exist.

FIG. 4 shows a functional layer of the platform 8, as it can be embodied in the memory of the server 102 described in FIGS. 1 and 2. Software, programmed in lines of codes works generally with different functional modules, each for performing a different function either serially or alternatively via tabs to be selected by users. FIG. 4 shows how Different modules are connected to a database manager 85, for the transfer of data. The database where data is stored and located under different indexing fields. Four module, a catalog (data storage and retrieval) module 81, an opportunity finding module 82, a priority ranking module 83, and a reporting and mapping module 84 as shown. Generally, the information collected and assembled must be catalogued using the catalog module 81, then processed to objectively qualify opportunities 82, then filtered using the priority ranking module 83, and finally reported and mapped using the mapping module 84 to the user in some type of visual display.

FIG. 5 provides a greater level of detail for each of modules 81, 82, 83, and 84. The first module 81, called a catalog module (a/k/a the Cataloguer) is software capable of generating different types of templates and data collection tools. This module serves as the gatekeeper to help understand the different parameters and limitations of the work to be performed by the next module 82. In this module, a user is asked to enter a list and inventory of the different products ultimately targeted by the system 100. Associated with this product/service, are multiple key business parameters. For example, in the case of a drug manufacturer, a single drug can be entered, but associated with it will be different classifications, target markets, target indications, regulatory status, commercial status, licensing partners, geographic presence, countries, etc.

Template Example

| | | | |
|---|---|---|---|
| Product(s): | Drug 1 | Drug . . . | Drug N |
| Market(s): | Country 1 | Country . . . | Country N |
| Regulation(s): | Rule 1 | Rule . . . | Rule N |
| Status: | Per market | Per market | Per market |
| Licensing: | Per market | Per market | Per market |
| Partner(s): | Partner 1 | Partner . . . | Partner N |
| Partner market(s) | Set 1 | Set . . . | Set N |

As shown above, multiple different parameters are defined for the module. In the case of a drug market, one or more drugs can be entered (shown as the series 1 to N). For each drug, markets can be defined, such as for example geographical areas like countries. Since each country has specific regulations, approval processes, and associated delays, regulation rules can be entered as subfields for a mask for each of the different markets. Other parameters like the status (regulatory approved v. non approved) can also be applied. This may correspond to the case for pursuing regional vs. country specific product development, and approvals would have an influence on the value and desirability of entering into any new market. Other parameters would for example include the capacity and need to license and protect the drug using intellectual property, the capacity to rely on existing partners in the different markets, and so on. One of ordinary skill in the art will understand that while one type of data cataloging is shown, what is contemplated is the entry of information for multiple items of interest for which a global optimization strategy is desired. For GeoDecision™ information about a company's current portfolio of products, partnerships and in-country capabilities will be catalogued. For GeoSequence™ sourced information catalogued will be more related to country economics, potential demand for a new product or service, customer access, and ease of conducting business in a given country. As part of the database manager 85, data for each of the modules is indexed and easily accessible and retrievable.

As part of the system 100, data is crawled or assembled using one of multiple ways. Either searches are run on the internet for the missing data or the data is input manually or electronically from a different database already in existence. For example, a drug manufacturer may have a database of existing relationships, patent approvals and licensing partners indexed by different countries around the world. What is contemplated is the use of this data merged into the data base using the database manager 85 as shown at FIG. 4.

Once a series of parameters has been defined by the catalog module 81, the next step is to determine and find key patterns in database records consistent with elevated levels of opportunity. This module allows for automated data search and analysis to identify the relevant patterns in the data. For a GeoDecision™ example, in a large number of countries, the existence of non-exclusive v. exclusive licenses allows a licensor to further increase sales by either selling directly in the non-exclusive jurisdiction or by giving a second license to a different party in the jurisdiction. In this example, the non-exclusivity of the license granted is an opportunity for more sales. Using and assigning mathematical factors of attractiveness to each opportunity, the module allows for objective scoring of the attractiveness of each country across a consistent set of attractiveness criteria. For example, a factor of K=1.5 could be given in countries where a non-exclusive license is given, K=1.25 where two non-exclusive licenses have already been granted and where the market is more likely to be saturated, and K=1 where an exclusive license is given.

At this early level of analysis of the analytical module 82, a template, as shown at FIG. 6, is then use to help apply the opportunity factor K to the different portions of the indexed database, and to correlate them to where it must be used. For example, the factor K can be given different weights ranging from, for example, 1.5 (plus 50% weight) down to 0.5 (minus 50% weight). As shown, a programming data entry analysis will then selected a factor K from the list (here 1, 2a, 2b, 2c, 3, 4a, and 4b). In this example the selection elements are shown as 30.

Template Factor Allocation

| Element | | | |
|---|---|---|---|
| List | Description | K | |
| 1 | Registered or approved but no one is selling | 1.5 | (150%) |
| 2a | Semi-exclusive, only one party licensed and | 1.25 | (125%) |
| | selling | | |
| 2b | Semi-exclusive, two parties licensed, one not | 1.20 | (120%) |
| | selling | | |
| 2c | Semi-exclusive, two parties licensed, one | 1.15 | (115%) |
| | selling, one not with regulatory withdrawal | | |
| 3 | Registered or approved, but limited | 1 | (100%) |
| | indications | | |
| 4a | Not registered or approved, no action | 0.90 | (90%) |
| 4b | Not registered or approved, regulatory files | 0.75 | (75%) |

withdrawn

For this single opportunity perceived, the coefficient used, such as a weighted factor helps sway the decision toward the different countries. What is further contemplated is the use at the time of entry of the factor K of an associated series of limitations 31 that help limit the factor only to certain parameters and not others. In this case, the perceived opportunity K factor can be limited by region, sub-region, country, partner, product, even product family 31. The mask used to limit each field is then saved as an opportunity report (i.e. one template per opportunity uncovered). The way to generate these reports is shown as 32. The module 82 can simply generate one opportunity report for each new opportunity, export to a file, or then create an overall report. These multiple opportunities (opportunity A, opportunity B, and opportunity C) can then each be associated with a different weighting factor K, F, G . . . each associated with a factor. The platform can then select the opportunities it wants and also offer how the use of multiple opportunities shall be handled arithmetically. For example, a 20% bias in two opportunities can be added (creating a 40% bias) or could be compounded (creating a 44% bias (1.2×1.2)). While two different multiple factor treatment calculations are given (i.e. K+F+G or K×F×G), what is contemplated is the use of any possible algorithm formulation to that is appropriate for the companies market environment to help achieve the optimization result.

Once multiple opportunities have been mapped using the analytical module 82, a module of priority ranking 83 then applies a consistent criteria set of attractiveness criteria to help discern most to least attractive opportunity to drive actual sales volume improvement. For example, for each country, the module 83 as shown at FIG. 7, will have a relevant population estimate, spending habits, volume of related sales, and ordinary known marketing data either as part of a stand-alone database or a third party database. FIG. 7 shows nine pie charts for different data displays. While a handful of charts are shown, what is contemplated is the display of charts based on a user's preferences. The first for example lists the volume of patients/inhabitants in the different tiers of country 91 (tier 1, tier 2, and tier 3 countries), the pie below 92 as a function of the % of disease for each countries of tier 1 and below is a chart of the same information in relation with patients of tier 2 93. The next column is the same information but based on the disease and sales volumes 94, and the third column the same information but for unit sales 95. From this data alone, countries with the largest pie portion will include the most patients for a disease, the most sales, and the most units sold. Without any of the opportunities layered upon this data, a user may wrongfully conclude that the countries with the largest markets are more attractive for global entry.

There may be a variety of such opportunities recognized, with each particular situation being somewhat unique because of the combination of business environment, product, geography, regulatory considerations, partners and partnering arrangements. Consequently, the value or attractiveness of each of these identified opportunities may be very different. GeoDecision™ attempts to quantitate or prioritize these situations in an analytical and objective way by assigning mathematical factors of attractiveness to the underlying components of identified opportunities, and calculating a combined score for each situation. In this way, management is better informed to make objective decisions based on quantitative metrics rather than a “seat-of-the-pants”, or more subjective evaluation.

In the above example in the drug industry, additional factors can be added as appropriate, including regulatory status, partner preference, logistical/infrastructure issues, product/partner/geographic financial history, and other relevant points of business differentiation. The opportunity attractiveness score is calculated from the series product of each of the component factors. This maintains the largely synergistic, mutually dependent relationship of the underlying attractiveness component factors. This calculation benefits situations where all factors are at least somewhat favorable, and appropriately penalizes instances where one or more of the underlying factors are significantly impaired.

Ultimately, the priority ranking module 83 will rank each of the items of interest, such as countries for the global potential of prioritized participation and optimization using, a Combined Attractiveness Score (CAS). The last module, the reporting and mapping module 84 as shown at FIG. 8, each of the countries are used to offer a visual and graphical representation of the CAS for each of the items of interest. Multiple different ways to display the CAS calculated with greater detail at FIG. 8, by using for example color or shades. One of ordinary care will recognize that while one representation is shown as part of the reporting and mapping module 84, what is contemplated is any type of active and highlighted representation of the information calculated below.

FIG. 9 shows how an overall CAS 45 can be calculated for each of the countries (in GeoSequence™) or opportunity (in GeoDecision™). Opportunity or country ranking are based from score against attractiveness criteria. For each of GeoSequence™ and GeoDecision™, one possible formula is used to determine the overall score 45. For example, for GeoDecision™, the following formula may be used:

Country Factor (CF)=(V/Vmax*B/Bmax*E/Emax*A/Amax)¼.

Where the ratio of V/Vmax for example when Vmax is a proportion (from 0 to 1 or 0% to 100%). While a linear extrapolation is shown above, what is contemplated is the use of any type of system to calculate the number.

For example, in GeoSequence™, the following formula may be used:

CF=A^{Pa}×B^{Pb}×C^{PC}×D^{Pd}

Where A, B, C, and D are calculated from empirical measurements, and where Px (i.e. Pa, Pb, Pc, and Pd) is determined to optimize the correlation with known values or sequences for attractiveness. In one preferred embodiment, A, B, C, and D, are the Volume (V) 41, the Ease (E) 42, the Access (A) 43, and the Burden (B) 44 respectively. In this example, CF becomes the attractiveness (ATT). The formulation becomes: ATT=V^{Pv}×E^{Pe}×A^{Pa}×B^{Pb}. This allows for a more accurate ranking of the different countries to enter produced 45 and instead of being a simple weighing calculation.

The opportunity or country score is reflected across (one to four predefined Criteria: Volume, Burden or Demand, Access, and Ease. For each location as shown at FIG. 6, a country will have a relevant population size and economic Gross Domestic Product (GDP) that result in a certain potential ‘volume’ of financial weight. The model of FIG. 9, is based on four discrete factors characterizing Volume, Burden, Access, and Ease to calculate CAS. First the Volume 41 is the magnitude of potential consumption in a given country. This is based largely on the population of relevant consumers within the target country, but may be modified based on demographic or geoeconomic factors. For example, in the above example, the Russian Federation volume is 0% to indicate that no volume can be achieved in this jurisdiction relative to the largest country, United States.

Next is a Burden 42. This factor is a measurement of the underlying inherent demand within a population. In the context of health care, this is commonly tied to the incidence or prevalence and diagnosis rate of related disease. As shown, as for the volume 41, the burden 42 is given as a fraction of 1. The next factor at FIG. 9 is the Access 43. This number corresponds to the degree to which the consuming population within the target country has sufficient means and opportunity to acquire and consume products, goods, and services. In the context of health care, this equates to the population's level of access to medical resources, product or service payment, and provider availability to patients. The final number is the Ease 44. This factor represents a measure of the degree to which the target business can be conducted within the identified country. This can be characterized by economic and regulatory measurements of business environment, as well as, a company's existing infrastructure and capability within each country. As shown, when a factor is nullified or not to be taken into consideration, a unitary value (e.g. 100%) can be used.

Each of these factors 41, 42, 43, and 44 is calculated from indices generated from independent measurements of relevant quantitative metrics in each category. Each factor is normalized to produce a percentile index based on the maximum value in the category. In addition, each metric used in the calculation of Volume, Burden, Ease, and Access is normalized to the maximum in the category. This is done to prevent the calculated values from being systematically influenced because of the particular metric(s) chosen.

What is described herein is a computer enabled software system 100 for the generation of a global optimization strategy of an item or collection of items or services of interest, such as a drug, into a plurality of jurisdictions like countries around the world. The computer enabled system 100 can include at least a computer 102 having a CPU 6A for executing a software 8 and a memory 7A connected to the CPU 6A for operating the software 8 within the memory 7A. The computer, as is generally the case can include a computer interface 10 and a display 9. The software 8 can be programmed for generating a global expansion strategy into a plurality of jurisdictions (countries) of an item of interest, such as a drug. The software 8 as shown at FIG. 4, can include in connection with a database manager 85, a catalogue module 81 to enter at least one item of interest to be the basis of a global expansion strategy, at least a business parameter associated with the at least one item of interest, and upload data from a network, a database, or a manual entry. Also an analytical module 82, and a priority ranking module 83 to help rank the plurality of jurisdictions based on an overall score calculated by the priority module for each of the jurisdictions based for the item of interest based on at least the business parameter entered in the catalog module 81 as shown at FIG. 10, data entered in the analytical module 82.

The system 100 can further include a color-coded reporting and mapping module 84 for displaying on the display to a user the data generated by the priority ranking module 83 as shown at FIG. 8. The analytical module 82 includes a template for entry of an attractiveness factor as shown at FIG. 6 for each of the jurisdictions of the item of interest. The overall score 18 as shown at FIG. 10, can be calculated using the attractiveness factor K as described above. The overall score 18 as shown at FIG. 9 obtained by using a volume score 41, a burden score 42, an access score 43, and an ease score 44.

Several methods are also contemplated in association with the novel system described above. For example, what is contemplated is a method shown at FIG. 11. A method of use of a computer enabled software system for the generation of a global optimization strategy 1000 of an item of interest into a plurality of jurisdictions, the method comprising the steps of using at least a computer having a CPU for executing a software and a memory connected to the CPU for operating the software within the memory, the computer further including a computer interface and a display, the software programmed for generating a global expansion strategy into a plurality of jurisdictions of an item of interest, the software including at least the following modules in connection with a database manager, a catalogue module to enter at least one item of interest to be the basis of a global optimization strategy, at least a business parameter associated with the at least one item of interest, and upload data from a network, a database, or a manual entry, an analytical module, and a priority ranking module to help rank the plurality of jurisdictions based on an overall score calculated by the priority ranking module for each of the jurisdictions based for the item of interest based on at least the business parameter entered in the catalog module, data entered in the analytical module, wherein the computer is used 1001 to enter at least one item of interest in the catalog module, entering at least one business parameter 1002 into the catalog module, uploading data 1003, 1004, or 1005, entering 1006 an opportunity type in the analytical module, and calculating 1007 using the priority ranking module a calculation of the overall score 1009 and priority of the item of interest into the jurisdictions. The method can further comprise the step of using the reporting and mapping module 1010 to display the overall score on a map. The method can further includes the step of discovering and entering the attractiveness factor for each of the criteria jurisdictions of the item of interest.

LaunchPath™

In one embodiment, the inventors have named the first use of this technology LaunchPath™. This system is a database application designed to aid with the management of a complex project that requires multifunctional planning and execution over time, such as the development, market preparation and launch of a new drug over the span of several years. LaunchPath™ is principally directed at improving decision making and optimizing management of very large projects linked with the global sales strategies, for example of new drugs commercialized by both large and small pharmaceutical or biotechnology companies.

The first step in the methodology used by the inventor is to structure the project information, key initiatives and project activities into an organized and coherent data matrix. For every complex project, the tasks can be broken down into different fields each representing, for example, skills possessed by a critical set of activities that may involve many different functions over time.

For example, in a project where a researcher, a manager, and a patent attorney are asked to work in tandem, the project can be broken down into three dimensions, each representing the skills unique to one of these three individuals. As shown at FIG. 13, a pharmaceutical project can include a first dimension that involves leadership, R&D, and marketing to consider the ultimate product's opportunity and approach to realize it (e.g. the preparation of a strategy 406), a design dimension to clarify the target product profile, development, and lifecycle plan (e.g. the preparation of the product 405), a marketing dimension to help educate clinician and patients about the disease or unmet need of a particular condition (e.g. the preparation of the market 404), a marketer dimension to define the brand identity and how it will be communicated (e.g. the branding 403), and a resource dimension to determine what level of people, talent, and dollars are required to deliver on the above dimensions (e.g. the preparation of an organization 402). While one of ordinary skill in the art will understand that each of these discrete dimensions are not really exclusively reserved to a specific function what is understood is that each of the dimensions has a discrete set of initiatives that is critical to a products approval, launch, and adoption.

A first software module, called the dimension generation module 450 as shown as part of the system 400, is represented functionally at FIG. 17. The module 450 allows the entry of multiple different dimensions 402, 403, 404, 405, and 406 as shown at FIG. 13. In one embodiment, the module 450 associates an iconography and a color with each of the dimensions. While the use of color or iconography is shown, what is contemplated is the use of any visual techniques to help a user to create (and later navigate) between these different dimensions. For example, a control panel or menu of options is used by a pilot to discern navigation, plane mechanicals, speed, fuel usage etc. For each, an icon is created to help the user quickly find and then navigate the primary dimension of interest.

A second software module, called the evolution module 451, allows a user of the system 400 to break down the project according to different clinical phases and commercial requirements during that each phase to start, manage, finish, and meet different milestones. As shown at FIG. 13, the evolution module 451 can in the case of a drug development generate different phases like a pre-clinical phase 407, a phase I safety drug testing phase 408, a phase II human safety drug testing phase 409, a phase III human efficacy drug testing phase 410, a filing phase 411, and a launch phase 412. For each, different clinical milestones can correspond to commercial planning phases. These are demarcations over time, that may begin with early product development, or when a product is acquired or being licensed.

Evolution Module 51 Breakdown:

| Name of Phase | Duration/Connection | Commercial Stage | End Milestone |
|---|---|---|---|
| Pre-clinical (7) | to Phase I | Opportunity | Entry into |
| | | Assessment | Phase I |
| Phase I (8) | to Phase II | Commercial | Entry into |
| | | Assessment | Phase II |
| Phase II (9) | to Phase III | Initial Commercial | Entry into |
| | | Strategy | Phase III |
| Phase III (10) | to Filing | Refined | Decision to |
| | | Commercial | File |
| | | Strategy | |
| Filing (11) | to Approval/Launch | Initial Launch | Decision to |
| | | Preparation | Commercialize |
| Launch (12) | | Launch | Post-Launch |
| | | Preparation | Review |

In the athletics example provided above, using a more simplified and only two dimensional approach, a triathlete may break down the road ahead to the Olympics as:

| Name of Phase | Duration/Connection | Stage | End Milestone |
|---|---|---|---|
| Endurance | to Regional Tryouts | Age Group Status | to Regional |
| Buildup | | | Tryouts |
| Racing Practice | to Regional Tryouts | Age Group Status | to Regional |
| | | | Tryouts |
| Performance | Routine | All American | Race Victory |
| Review | | Status | |
| Regional Tryouts | Fixed Date—Event | Elite Status | Within top 3 |
| | | | selected for |
| | | | Nationals |
| National Tryouts | Fixed Date—Event | Pro Status | Within top 10 |
| | | | selected for |
| | | | Olympics |

In the above table, the road to the Olympics can be broken down into different phases, the first to build endurance and lose fat, the second to begin racing in different races, the third as the routine review of performance and analysis, the last two phases as shown are associated with the regional tryouts, and the national tryouts. As shown in the milestones, without a race victory in a performance review (i.e. winning a small local race), there is no point in entering the regional tryouts in turn to qualify to the national tryouts. Stages in this example can be associated with the different status of athlete given the United States Triathlon Association. For example, an athlete competes within age group. Some of the best age groupers are advanced by the national federation to All-American status. Some will turn elite or pro. In each case, very precise performance milestones are needed.

Once the project has been broken down using the first and second modules 450, 451, a third software module is employed to identify the activities required to meet milestones for the relevant dimension, named the subtask module 452 to allows a user to breakdown each of the dimensions 402, 403, 404, 405, and 406 into different subgroups. At FIG. 14, the dimension is broken down into initiatives 422, and activities 423. As shown, in addition to a color or an iconography, a numbering/lettering system can be used. In this case, the phase of preparation of strategy 406 can be given the letter A. The first initiative (subgroup) is called as shown the situation assessment and is given the number A.1 as the first initiative. A subsequent initiative would be given the number A.2 and so on. As shown at FIG. 14, subgroups used may include a second level called for example the activities 423 defining more precisely the task at hand.

In the example shown at FIG. 17, these activities are given a sub-number 427. As shown, the activities are numbered from 01 and up and the resulting indexing number for these activities can be A.1.01, A.1.02, A.1.03, and so on. Each is given a titled 428, a description 424, and multiple fields unique to the activity 425, 426, 428. In the example given, in the context of a drug being released, the first initiative being a situation assessment A.1 as part of the initial preparation strategy 406. The first four activities can include A.1.01—Market Opportunity Analysis, A.1.02—Environment Assessment, A.1.03—Disease State & Treatment for their respective titles.

Continuing the above example in the, the first dimension described was running. The subtask module 452 can take the code to this dimension given by the dimension module 450 (e.g. A). The first initiative could also be situation assessment and be given a letter A.A. Activities can include A.A.01—Purchase footwear, A.A.02—Purchase heart rate monitor, A.A.03—Cardio test. While two examples are given as to how different situations and projects, what the contemplated is a system capable of processing any different project for any type of situation.

The fourth module, is directed to a customizable indexing matrix module 453, where a user for each of the activities 423 of the subtask module 452, the different activities will be associated with one or more of the parameters of the evolution module 451. For example, a user of the system 400 may click on the Phase I icon at FIG. 13 and want to see all activities 423 that are generated by the subtask module 452 indexed for this Phase. A user may also click on a critical milestone, or a commercial stage as shown at FIG. 13 to index the different subtasks 452.

One of the dimension (i.e. prepare brand 403) may for example include tasks to be performed at the time of filing 411 and approval 412. In the above athletics the athlete may want to know for a the national tryouts only, what are the unique subtasks on each of the dimensions (i.e. running, biking, swimming, nutrition, weight control) associated. For example, the athlete may have values of fat reserves to attain, different pacing per mile, and volume of training in open water.

As shown at FIG. 14, each activities is indexed by a project lead or functional area 425 (i.e. the corporate department), the different participants 26, and other items like an opportunity assessment 428A, a refined commercial assessment 428B, an initial commercial strategy 428C, a refined commercial strategy 428D, and an initial launch preparation 428E.

The matrix module 54 can be made to be intuitive and easy to fill-in by using multiple pre-populated or user defined templates. FIG. 15 shows examples of three possible templates 431, 432, 433. In each, a user will be requested to structure the data entry, fill in the fields, and ultimately find and fix the different indexing parameters. As shown, these three pages also appear as reporting tools, and a report for any given activity. LaunchPath™ allows the use to upload or download completed documents that are available to share with others or to hold a current record. Here the Brand Vision & Strategic Direction—A.3.01 can be displayed on several pages. As shown at FIG. 15, one of the main advantage of this system and software is the ease in access, learning and filling. By using prepopulated packages in each field, the software can be customized for any type of industry. What is contemplated is the sale of services in association with the software interface to help generate templates and pre-filled information within the software. What is also contemplated is a database 455 shown at FIG. 17, connected with the software and the different modules 450, 451, 452, 453, and 454, to store, retrieve, and index different types of content in association with each of the templates. This database can be linked to a document management system. For each activity, a template describes the key questions to be addressed and associated examples. It allows for additional project documents to be uploaded and accessed by other appropriate team members.

Described is a computer enabled software system for planning the launch of a new product, the computer enabled software system comprising as shown at FIGS. 1 and 2 at least a computer 102, 104, 105, 106, and 108 having a CPU 6A, 6B, for executing a software 8 and a memory 7A, 7B connected to the CPU 6A, 6B for operating the software 8 within the memory 7A, 7B, the computer including a computer interface 10 and a display 9, the software programmed for generating a launch optimization of a project, the software including at least the following modules shown at FIG. 17, a dimension generation module 450 for the entry by a user of a plurality of dimensions each associated with the project, an evolution module 451 for the entry by the user of a plurality of project phases each associated with the project, a subtask module 452 for the entry by the user of a plurality of initiatives each as sub-elements of a dimension entered in the dimension generation module, and for the entry by the user of a plurality of activities each as sub-elements of the plurality of initiatives, and a matrix and template module 453.

In another embodiment, the system 8 includes a status reporting module 454, for displaying for each of the activities of the subtask module a full overview of the activity including at least a connection to at least one of the plurality of project phases from the evolution module 451. Reporting capabilities allow for views across any or all dimensions, and can include the following additional analyses: Activity Slip Index, Critical Path Analysis, Resource Mapping, Functional Dependencies, Task Completion Analysis, Updates, and Activity Calendar. The dimension generation module 450 can associate each of the plurality of dimensions 461 associated with the project at least one of the group consisting an icon or a color 462 as shown at FIG. 18. The evolution module 451 can also include the entry 464 of a name, duration, a connection, a stage, and a milestone to each of the project phases 463 entered by the user also as shown at FIG. 18.

The matrix and template module 453 can also for each of the plurality of activities entered in the subtask module by the user as shown at FIG. 18 and where a plurality of templates 466 is offered to the user via the matrix and template module to help with the entry of information 467. The matrix and template module 453 includes a function to generate new templates 468 to be offered to the user. The template of an activity includes either one of a project lead, a list of participants, or a person responsible for performing the activity as shown in FIGS. 12 to 8. The template or how-to guide can include one of a group consisting of an opportunity assessment, a refined commercial assessment, an initial commercial assessment, a refined commercial strategy, and an initial commercial strategy as shown at FIG. 18. The plurality of templates is offered to the user via the matrix and template module to help with the entry of information, and the template includes one of the name, the duration, the connection, the stage, and the milestone to each of the project phases 464.

What is shown at FIG. 19, is a method 2000 of use of a computer enabled software system for a launch optimization of a project, the method comprising the steps of: using at least a computer having a CPU for executing a software and a memory connected to the CPU for operating the software within the memory, the computer further including a computer interface and a display, the software programmed for generating a launch optimization of a project, for entry by a user in a dimension generation module 2001 a plurality of dimensions each associated with a project, entering in an evolution module 2002 a plurality of project phases each associated with the project, and entering in a subtask module 2003 a plurality of initiatives each as sub-elements of a dimension entered in the dimension generation module and for the entry of a plurality of activities each as sub-elements of the plurality of initiatives, and wherein the entry is via a matrix and template module 2005 to facilitate entry of the initiatives and activities.

The method as shown at FIG. 19 includes the step of using a reporting module 2004 for displaying a full overview of the activity including at least a connection to at least one of the plurality of project phases from the evolution module. The method also includes the entry in association with each of the plurality of dimensions associated with the project at least one of the group consisting an icon or a color 2006. The method also includes the step 2008 of using the evolution module includes the entry of a name, duration, a connection, a stage, and a milestone to each of the project phases entered by the user.

Also shown at FIG. 19, the method includes the step of giving access to the matrix and template module 2005 for each of the plurality of activities entered in the subtask module by the user. The step includes the access of a plurality of templates offered to the user via the matrix and template module to help with the entry of information. The matrix and template module includes a function to generate new templates 2007 and offering this new template to the user. The template of an activity can include 2009 either one of a project lead, a list of participants, or a person responsible for performing the activity and the user enters either of the project lead, the list of participants, and the person responsible. The template and associated method of use can include the step of using the template with one of a group consisting 2010 of an opportunity assessment, a refined commercial assessment, an initial commercial assessment, a refined commercial strategy, and an initial commercial strategy. Finally, 2011 to help with the entry of information, and the use enters into the template one of the name, the duration, the connection, the stage, and the milestone to each of the project phases.

It is understood that the preceding is merely a detailed description of some examples and embodiments of the present invention and that numerous changes to the disclosed embodiments can be made in accordance with the disclosure made herein without departing from the spirit or scope of the invention. The preceding description, therefore, is not meant to limit the scope of the invention but to provide sufficient disclosure to one of ordinary skill in the art to practice the invention without undue burden.

1. A computer enabled software system for the generation of a global optimization strategy of an item or collection of items (item) of interest into a plurality of jurisdictions, the computer enabled system comprising:
at least a computer having a CPU for executing a software and a memory connected to the CPU for operating the software within the memory, the computer further including a computer interface and a display, the software programmed for generating a global expansion strategy into a plurality of jurisdictions of an item of interest, the software including at least the following modules in connection with a database manager:
a catalogue module to enter at least one item of interest to be the basis of a global optimization strategy, at least a business parameter associated with the at least one item of interest, and upload data from a network, a database, or a manual entry;
an analytical module; and
a priority ranking module to help rank the plurality of jurisdictions based on an overall score calculated by an algorithm to score and prioritize each of the jurisdictions based on at least the business parameter entered in the catalog module, and data entered in the analytical module.

2. The computer enabled software system of claim 1, further including a color-coded mapping module for displaying to a user the data generated by the priority ranking module.

3. The computer enabled software system of claim 1, wherein the analytical module includes a template for entry of an attractiveness factor for each of the jurisdictions of the item of interest.

4. The computer enabled software system of claim 3, wherein the overall score is calculated using the attractiveness criteria.

5. The computer enabled software system of claim 4, wherein the overall score further includes a Combined Attractiveness Score obtained by using a volume score, a burden score, an access score, and an ease score.

6. The computer enabled software system of claim 2, wherein the jurisdictions are countries and the item of interest is a drug, medical product, technology, or service.

7. The computer enabled software system of claim 1, wherein the business parameter is selected from a group consisting of a market, a regulation, a status, a licensing status, a local partner, and the markets of local partners.

8. A method of use of a computer enabled software system for the generation of a global optimization strategy of an item of interest into a plurality of jurisdictions, the method comprising the steps of:
using at least a computer having a CPU for executing a software and a memory connected to the CPU for operating the software within the memory, the computer further including a computer interface and a display, the software programmed for generating a global expansion strategy into a plurality of jurisdictions of an item of interest, the software including at least the following modules in connection with a database manager, a catalogue module to enter at least one item of interest to be the basis of a global expansion strategy, at least a business parameter associated with the at least one item of interest, and upload data from a network, a database, or a manual entry, an analytical module, and a priority ranking module to help rank the plurality of jurisdictions based on an overall score calculated by the priority ranking module for each of the jurisdictions based for the item of interest based on at least the business parameter entered in the catalog module, data entered in the analytical module, wherein the computer is used to enter at least one item of interest in the catalog module;
entering at least one business parameter into the catalog module;
uploading data;
entering an opportunity type or defining attractiveness criteria in the analytical module; and
calculating using the priority ranking module a calculation of the overall score and priority of the item of interest into the jurisdictions.

9. The method of claim 8, wherein computer enabled software system further includes a reporting and mapping module for displaying on the display to a user the data generated by the priority ranking module, and the method further comprising the step of using the reporting and mapping module to display the overall score or individual criterion scores on a map.

10. The method of claim 8, wherein the analytical module includes a template for entry of an attractiveness factor for each of the jurisdictions of the item of interest, and the method further includes the step of discovering and entering the attractiveness factor for each of the jurisdictions of the item of interest.

11. The method of claim 8, wherein the overall score is calculated using the attractiveness factors.

12. The method of claim 9, wherein the jurisdictions are countries and the item of interest is a drug, medical product, technology or healthcare-related service.

13. The method of claim 8, wherein the business parameter is selected from a group consisting of a market, a regulation, a status, a licensing status, a local partner, and the markets of local partners, and the step of entering the business parameter includes the step of entering a second business parameter also selected from the group.

14. A method of use of a computer enabled software system for the generation of a global strategy into a plurality of jurisdictions, the method comprising the steps of:
using a computer enabled software system for the generation of a global optimization strategy of an item of interest (GeoDecision);
using a computer enabled software system for a prelaunch through launch planning and execution of a project (LaunchPath); and
using a software to optimize a geographic launch sequence (GeoSequence).
